(19) United States
(12) Patent Application Publication
(10) Pub. No.: US 2004/0089837 A1
(43) Pub. Date: May 13, 2004

(54) Multple valve arrangement for flowing media

(76) Inventors: Bertram Bauer, Gaggenau (DE); Jens Schrader, Buehlertal (DE); Klaus Strassburger, Rheinmuenster (DE); Wolfgang Paessler, Achern (DE)

Correspondence Address: Striker Striker & Stenby, 103 East Neck Road, Huntington, NY, 11743, US

(21) Appl. No.: 10/471,248

(22) PCT Filed: Oct. 15, 2002
(86) PCT No.: PCT/DE02/03868

(30) Foreign Application Priority Data
Feb. 2, 2002 (DE) 10204250.0

(51) Int. Cl. F16K 1/00

(52) U.S. Cl. 251/367

(57) ABSTRACT

In order to produce very complex fluidic connections of valves in an extremely small amount of space, a multivalve unit for flowing media such as air, water, or another fluid, has a sandwich-like plate structure (12) composed of two outer conduit plates (13, 15) and a central sealing plate (14) situated between them, as well as a housing (11) enclosing the plate structure (12). Front plate surfaces (131, 151) of the conduit plates (13, 15) oriented toward the sealing plate (14) are provided with flow conduits (16) that are covered by the sealing plate (14), and the back plate surfaces (132, 152) of the conduit plates (13, 15) are provided with inlet and outlet openings (17, 18) that communicate with flow conduits (16) (FIG. 1).

### PRIOR ART

The invention is based on a multivalve unit for flowing media such as air, water, or another fluid, as generically defined by the preamble to claim 1.

Multivalve units of this kind are used for connecting valves in a fluidically simple way without separate pressure lines. In this connection, it is known to produce valve conduits out of an elastomer and to seal them with a sealing plate. A screw connection attaches the elastomer to the sealing plate. Solenoid valves are positioned on the back side of the elastomer and are connected to the conduits by means of through bores.

### ADVANTAGES OF THE INVENTION

The multivalve unit according to the invention, with the features of claim 1, has the advantage of a fluidic connection of a large number of valves in an extremely small amount of space. The conduit cross sections for connecting the valves can be designed as large since the rigid conduit plates—by contrast with the known elastomer—are not deformed when the sealing plate is pressed against them to produce the sealed seating. For a desired modification of the connection, in many cases, it is only necessary to change one of the three plates of the plate sandwich. The sandwich construction, with the possibility that it affords for a multilayer conduit routing, permits very fluidically complex connections of valves to be designed in which it is also possible for the flow conduits to cross over one another. The multivalve unit according to the invention is particularly well suited to production and easy to repair, which therefore reduces costs.

Advantageous modifications and improvements of the multivalve unit disclosed in claim 1 are possible by means of the measures explained in the remaining claims.

According to an advantageous embodiment of the invention, the sealing plate has through openings let into it, which connect selected flow conduits in the two conduit plates to one another. This structural feature can be used to produce freely selected connections between the conduits in the upper and lower conduit plates and therefore between the valves, including a crossing of the conduits over one another, in a simple manner.

According to an advantageous embodiment of the invention, the back plate surfaces of the conduit plates, which surfaces have the inlet and outlet openings for the valves, are provided with sealing elements that produce the tight seal between the conduit plates and the housing. As a result, upon insertion of the plate sandwich into the housing and the exertion of a minimal contact force between the housing and the plate sandwich, the tight seal between the inlet and outlet openings and the valves disposed in the housing is automatically assured by means of the assembly.

According to an advantageous embodiment of the invention, the housing is composed of two housing halves, each of which rests against the sealing elements of one of the conduit plates, and the two housing halves are fastened to each other, exerting a compressive force on the plate sandwich. The fastening is preferably executed by means of a positively and frictionally engaging detent connection that is embodied after the fashion of a slide fastener extending in the longitudinal direction of the housing. These structural features achieve a uniform distribution of the surface pressure over the entire plate sandwich so that all of the sealing elements and sealing edges press against the conduit plates with a uniform contact force.

According to an advantageous embodiment of the invention, both longitudinal sides of the housing halves are provided with tooth-like struts oriented toward each other so that the struts of the one housing half can be slid in a positively engaging manner into the gaps between the struts on the other housing half. The detent connection of the housing halves is produced at the struts by inserting a wedge clamp connector in the longitudinal direction of the housing along each of the two rows of struts with interlocking teeth, so that its wedge surfaces on opposite sides engage behind corresponding wedge surfaces that are disposed in alternation on succeeding struts in the insertion direction. Such a wedge clamp connection between the two housing halves permits compensation for manufacturing tolerances and assures a uniform distribution of force to all sealing surfaces.

### DRAWINGS

The invention will be explained in detail in the following description in conjunction with an exemplary embodiment depicted in the drawings.

FIG. 1 shows a perspective exploded view of a multivalve unit, FIG. 2 shows a section along the line II-II in FIG. 1,

FIG. 3 shows a section along the line III-III in FIG. 1.

### DESCRIPTION OF THE EXEMPLARY EMBODIMENT

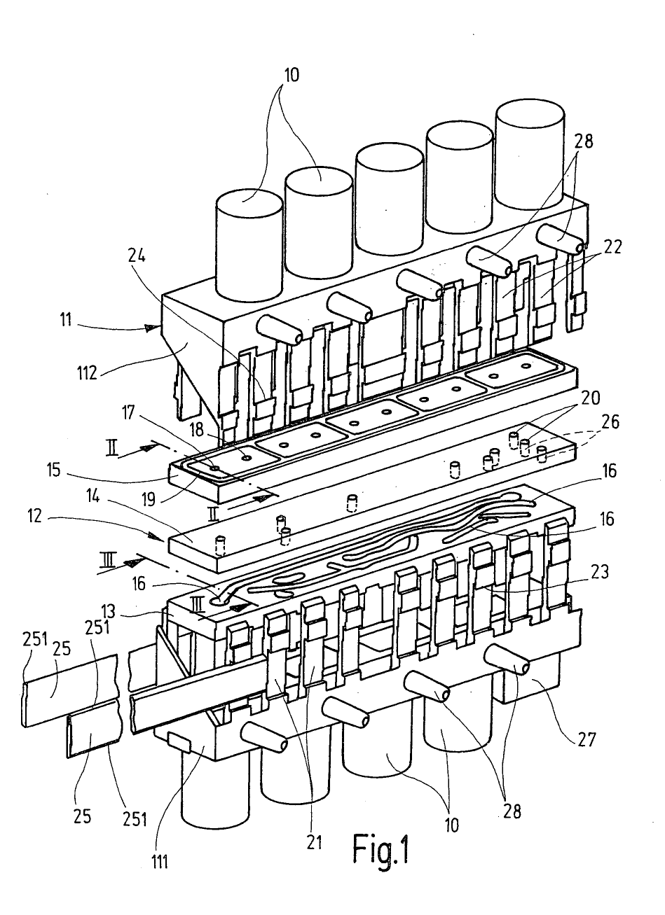

The pneumatic multivalve unit that is shown in an exploded view in FIG. 1 is an exemplary embodiment for a multivalve unit for a universal flowing medium, such as air, water, hydraulic fluid, and the like, includes a total of nine pneumatic valves, but it is possible for it to be provided with any number of pneumatic valves. For the sake of clarity, the only parts of the pneumatic valves that are shown are the control elements or actuators 10 for actuating the valves. These actuators 10 can be of the pneumatic or electromagnetic type. The valve elements of the individual pneumatic valves actuated by the actuators 10 have been omitted from the drawing.

The multivalve unit has a housing 11, which is composed of two housing halves 111 and 112. Each housing half 111, 112 has a particular number of pneumatic valves integrated into it. In the exemplary embodiment in FIG. 1, five valves are integrated into the upper housing half 112 and therefore five actuators 10 are provided for valve actuation, whereas the lower housing half 111 is only provided with four valves. A valve connection 28 is provided on the housing 11 for each valve. FIG. 1 does not show another connection provided on the housing 11 for jointly supplying all of the valves.

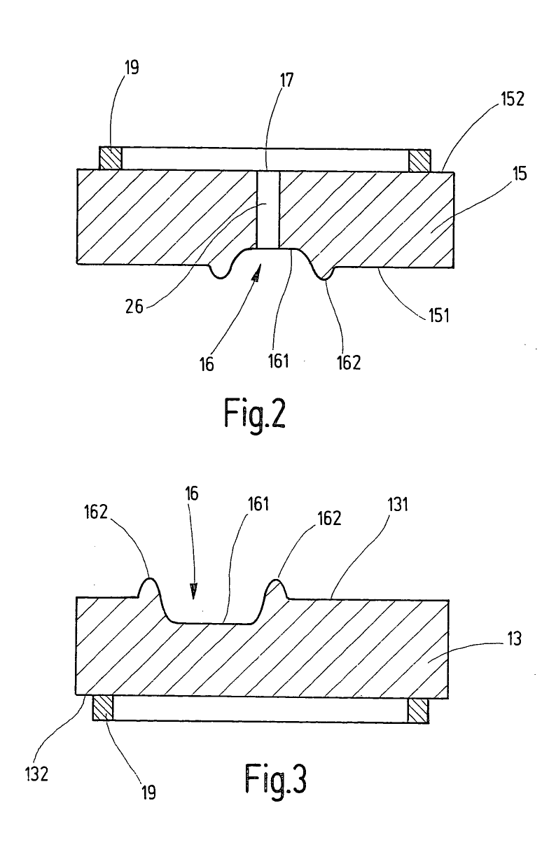

The housing 11 accommodates a sandwich 12 composed of three stacked plates 13, 14, 15. This sandwich 12 includes two conduit plates 13 and 15 on the outside and a central sealing plate 14 situated between them. The front plate surfaces 131, 151 of the conduit plates 13, 15 oriented toward the sealing plate 14 are provided with flow conduits 16, and the back plate surfaces 132, 152 oriented away from the sealing plate 14 are provided with inlet and outlet openings 17, 18 for the valves and sealing elements 19, which produce the tight seal between the conduit plates 13, 15 and the housing halves 111, 112. The inlet and outlet openings 17, 18 are each connected to one of the flow conduits 16 by a bore 26 passing through the conduit plate 13 or 15 and are opened or closed by the valve elements of the valves. In FIG. 1, the flow conduits 16 are only shown in the lower conduit plate 13 and the inlet and outlet openings 17, 18 together with the sealing elements 19 are only shown in the upper conduit plate 15. Enlarged depictions of the flow conduits 16 and sealing elements 19 are given in the cross sectional views in FIG. 2 for the upper conduit plate 15 and in FIG. 3 for the lower conduit plate 13. As is clearly depicted there, the flow conduits 16 are embodied in the form of channels 161 that are incorporated into the conduit plates 13, 15 and are bounded at the sides by raised sealing edges 162. The geometry of the flow conduits 16 can be embodied in any shape; care must be taken that the flow conduits 16 in the same conduit plate 13 or 15 have no connection to one another. The central sealing plate 14 is provided with through openings 20 that are preferably embodied as bores. The through openings 20 are only provided at those locations on the sealing plate 14 where selected flow conduits 16 in the lower conduit plate 13 are to be connected to selected flow conduits 16 in the upper conduit plate 15.

After the conduit plates 13-15 are assembled to form the sandwich 12, the two housing halves 111 and 113 are slid from above or below onto the conduit plates 13 and 15, the sealing elements 19 resting against the rear plate surfaces 132, 152 of the conduit plates 13, 15. By fastening the two housing halves 111, 112 to each other, the lower housing half 111 is pressed against the sealing elements 19 on the lower conduit plate 13, the upper housing half 112 is pressed against the sealing elements 19 on the upper conduit plate 15, and the sealing plate 14 is pressed against the sealing edges 162 on the two conduit plates 13, 15, and thus a uniform force distribution over all of the sealing surfaces is achieved, which assures a tight seal.

The two housing halves 111, 112 are fastened by means of a positively and frictionally engaging detent connection after the fashion of a slide fastener extending on each side of the housing 11 in the longitudinal direction of the housing. To this end, tooth-like rows of struts 21 and 22 oriented toward each other on both longitudinal sides of each housing half 111, 112 are designed so that the struts 21 on the lower housing half 111 can be slid in a positively engaging fashion into the gaps between the struts 22 on the upper housing half 112 and vice versa. The struts 21 of the two strut rows on the lower housing half 111 are provided with protruding wedge surfaces 23 close to their free ends. Identical wedge surfaces 24 are situated close to the free ends of the struts 22 of the two strut rows of the upper housing half 112; the wedge surfaces 23, 24 are oriented so that when the strut rows are slid into one another, the wedge surfaces 23, 24 are oriented toward one another and spaced apart from each other. When the two housing halves 111, 112 are pressed together (which slightly increases the distance of the wedge surfaces 23, 24 from each other), on each side of the housing 11, a wedge clamp connector 25 is inserted, which has bevels 251 on its opposing longitudinal sides that are adapted to the wedge surfaces 23, 24. This wedge clamp connector 25 is inserted with its bevels 251 under the wedge surfaces 23, 24 on the struts 21, 22, where one bevel surface 251 comes to rest in alternation against a wedge surface 23 of a strut 21 and a wedge surface 24 of the other strut 22 and thus locks the two housing halves 111, 112 in detent fashion to each other while exerting a compressive force that acts on the sandwich 12.

Sensors for sensing the flowing medium, i.e. air in this exemplary embodiment, can also be accommodated in the multivalve unit described above. Such sensors can, for example, detect the temperature, the viscosity, or other parameters of the flowing medium. A sensor of this kind is used in lieu of a valve so that it can be disposed at the location of an actuator 10 in the housing 11. The probes of these sensors are inserted into corresponding inlet or outlet openings 17, 18 and thus come into contact with the flowing medium. FIG. 1 shows a sensor 27 of this kind in the lower housing half 111.

1. A multivalve unit for flowing media such as air, water, or another fluid, characterized by means of a sandwich-like plate structure (12) composed of two outer conduit plates (13, 15) and a central sealing plate (14) situated between them, as well as a housing (11) enclosing the plate structure (12), and characterized in that front plate surfaces (131, 151) of the conduit plates (13, 15) oriented toward the sealing plate (14) are provided with flow conduits (16) that are covered by the sealing plate (14), and the back plate surfaces (132, 152) of the conduit plates (13, 15) oriented away from the sealing plate (14) are provided with inlet and outlet openings (17, 18) for the valves that communicate with flow conduits (16).

2. The multivalve unit according to claim 1, characterized in that sealing elements (19) that produce the tight seal between the conduit plates (13, 15) and the housing (11) are disposed on the back plate surfaces (132, 152) of the conduit plates (13, 15).

3. The multivalve unit according to claim 1 or 2, characterized in that the flow conduits (16) are embodied in the form of channels (161) that are incorporated into the conduit plates (13, 15) and are bounded at the sides by raised sealing edges (162).

4. The multivalve unit according to one of claims 1 to 3, characterized in that the sealing plate (14) is provided with through openings (20), which connect selected flow conduits (16) in the two conduit plates (13, 15) to one another.

5. The multivalve unit according to one of claims 2 to 4, characterized in that the housing (11) is composed of two housing halves (111, 112), each of which rests against the sealing elements (19) of one of the conduit plates (13, 15), and in that the two housing halves (111, 112) are fastened to each other in the direction of this contact.

6. The multivalve unit according to claim 5, characterized in that the fastening is produced by means of a positively and frictionally engaging detent connection.

7. The multivalve unit according to claim 6, characterized in that the detent connection is embodied after the fashion of a slide fastener extending between the two housing halves (111, 112) in the longitudinal direction of the housing.

8. The multivalve unit according to claim 7, characterized in that tooth-like rows of struts (21, 22) oriented toward each other on both longitudinal sides of each housing half (111, 112) are embodied so that the struts (21, 22) of the one housing half (111, 112) can be slid in a positively engaging fashion into the gaps between the struts (22, 21) on the other housing half (112, 111), and in that the struts (21) of the one housing half (111) are locked in detent fashion to the struts (22) of the other housing half (112).

9. The multivalve unit according to claim 8, characterized in that the detent connection is produced by inserting a wedge clamp connector (25) along the alternating teeth of the two strut rows so that its bevels (251) oriented away from each other engage behind corresponding wedge surfaces (23, 24) that are embodied on succeeding struts (21, 22) in the insertion direction.

10. The multivalve unit according to one of claims 5 to 9, characterized in that each housing half (111, 112) is provided with actuators (10) for actuating valve elements that cooperate with the inlet and/or outlet openings (17, 18) on the back plate surfaces (132, 152) of the associated conduit plates (13, 15).

11. The multivalve unit according to one of claims 5 to 10, characterized in that at least one housing half (111, 112) is provided with sensors (27) that sense the flowing medium by means of probes inserted into the inlet or outlet openings (17, 18).
